(19) United States
(12) Patent Application Publication
(10) Pub. No.: US 2006/0202483 A1
(43) Pub. Date: Sep. 14, 2006

(54) Capturing energy from the rise and fall of the tides and waves of the ocean

(76) Inventor: Enrique Javier Gonzalez, Newport Beach, CA (US)

Correspondence Address: Enrique J. Gonzalez, 2181 Vista Entrada, Newport Beach, CA, 92660, US

(21) Appl. No.: 11/374,394

(22) Filed: Mar. 13, 2006

Related U.S. Application Data
(60) Provisional application No. 60/661,399, filed on Mar. 14, 2005.

(51) Int. Cl. F03B 13/12; F03B 13/10; H02P 9/04

(52) U.S. Cl. 290/53

(57) ABSTRACT

A heavy floating devise with one or multiple billows, accordions or balloons, attached on top, that are large enough and strong enough to cover all or most of the floating device's surface and can expand and contract as much as the floating devise lifts them and brings them.down pushed by the tides and the waves, because these accordions are firmly attached above, to an structure that is immobile, high enough, strong enough to withstand the pushing and pulling that the floating devise will exert through the accordions or billows, and to contain the lateral movement of the floating devise within certain parameters so that the floating devise goes almost exclusively up or down, those billows will inflate or deflate depending of the direction up or down of the floating devise, air will be pushed in or out of the accordion through constricted outlets controlled by valves some of them allow air in, some of them allowing the air out, directing, through ducts, the accelerated air to move a circular propeller or impeller, that will move a shaft to an accelerating gear box and that accelerated movement goes to a generator or alternator to generate electricity.

### CROSS REFERENCE TO RELATED APPLICATIONS

This application claims the benefit of Provisional Patent Application Ser. No. 60/661,399 filled 2005 Mar. 14 by the present inventor.

### BACKGROUND OF INVENTION—FIELD OF INVENTION:

This invention relates to harvesting or capturing the Lifting and Pulling Down Energy exerted on a floating platform when that platform compresses or expands a billow, air piston, rack, coil or spring against or from a firm and immobile platform to generate Electricity.

### BACKGROUND OF THE INVENTION

It is a natural phenomenon that occurs approximately every 12 hours, the ocean, due to the magnetism that the moon exert on the ocean water, creates a cycle in which the level of the water rises a certain number of feet (between 2 to 3 and 18 to 20), and then it comes down approximately the same number of feet, the movement is called Tides (high and low, rise or ebb). The variations on the amount of feet that the tide goes up or down is dependent on the faces of the moon among other factors,(increasing or decreasing magnetic force), weather and currents, and certain locations on the earth have tides that are much higher than in others.

The tide phenomenon is expected every day with a constant precision of time, two cycles every 24 hrs and approx. 20 minutes, 2 highs and 2 lows in an alternated sequence; that predictable swelling and shrinking has been used to generate energy, with the flow of the water going in and out of inlets, creating predictable currents.

The swells and waves of the ocean are much more frequent, irregular and certain unpredictability, added to their force and variation of direction and speed, create more of a challenge to capture its energy, but at the same time it can generate more energy than the predictable tides.

Most of previous invention concentrate on the capture of the energy from the flow of the water while my devices concentrate on the energy from the lifting and falling of the ocean surface when applied to a floating platform that is tied or rendered immobile laterally but when floating moves up and down freely, on top of that floating platform, or the floating device can be a chamber like a billow or accordion that expands higher than the highest tide or wave that can be predicted, and above, that billow, fastened or attached to a firm and immobile structure that resists the pressure of the billow, when the accordion or billow is pushed up, it forces the air inside to be expelled through a valve or valves to a propeller, that is attached to an accelerator gear an then to a generator or dynamo that creates electricity, and when the exhaling movement ends and the weight of the floating devise, pulled by the receding level of the water, starts to go down, the billow or accordion starts to inhale air, the exhaling valve or outlet valves closes and the inhaling valve or inlet valves opens, as the air comes into the hollow chamber, attracted by the negative pressure inside the billow, accordion or floating devise, before entering into the chamber, it passes through an impeller or the same propeller in a location or direction so the impelled and expelled air moves the propeller in the same direction, so when inflating, the air going in moves the turbine, when deflating, the air going out moves the turbine too, through the propeller, all this is generated by the rise and fall of the level of the water pushing or pulling the floating devise.

So we need: a) A floating device or platform, assigned A on FIGS. 1, 3, 4, 5, 6.7 and 8.3, of a certain weight so it can be pull down with the receding height of the water level. b) A billow, accordion FIGS. 1, 3, 4, 6, 7, 8.4 with the letter C, or the floating devise can be made part of the billow, that gets compressed an expanded vertically with the rise and fall of the height of the water. c) A firm immobile structure that: 1) holds the whole complex, capable to withstand the forces of the water, this can be accomplished by strong pillars, In the case of the waves in the ocean, stronger, than in the case of the tides in sheltered inlets, 2) can resist the pressure up and the pulling down of the billow or billows that are attached to it, 3) holds the floating devise, FIGS. 1, 3, 4, 5, 6, 7, 8.3 with the letter B, and billows in a way that are not moved sideways or horizontally beyond desirable parameters, allowing, through tracks or any other means unimpeded vertical movement, so, horizontal, and vertical strength, and firm anchoring is required, 4) has to be tall enough as not to interfere with the movements up and down of the floating devise and accordion during the highest tides and or swells or waves that can be expected.

So, in the case of the devise that works in tides there is less need for horizontal strength because it is placed in areas that are sheltered as marinas, inlets, sheltered harbors and sheltered bays where waves or swells are not of concern, but since there is very slow movement, there is need of large billows or inflatable devises to create volume, like old tankers, large barges or big floating platforms explicitly made for that purpose, under bridges, etc. always aiming at having large volume, as far as the imagination can take us; in the devise for the swells and waves, since they will be located where waves are constant, they need stronger structures, to tolerate the waves and the pull that they exert on the whole floating devices without letting them move horizontally within very limited parameters; some ideas for these structures are the piers, bridges, rocky structures that can allow to build on them such structures, oil platforms and between breakers, the shape of the bottom of the floating devices for the waves will have rounded up contours that can lift and fall fast under the push of the waves, and made of sturdier materials, can be a single floating platform with a single large billow covering the whole deck FIG. 7, or a long floating platform that teeter totter, with an accordion in front and another in the back, that when front goes up, back goes down front exhale, back inhale, it could have a center accordion, mounted above a hinged secondary deck that harvest the lift of the whole platform FIG. 6, there can be multiple, smaller, independent floating devices or platforms, each with its own billow, close to each other can be a honeycomb of united but independent floaters that move individually, each with its own inlet and outlet valve, the air inhaled or exhaled can be added to flow through connecting tubes and valves that allows all the air gathered from the exhaling billows to go in the same direction towards the propeller, and the inhaled air from the outside, through the impeller, towards the billow FIG. 6.

### SUMMARY

The concept of the devices that I present to you, capture the Energy that the water exerts on a heavy floating object when is pulled up and down with the rise and fall of the tides, swells or waves, expanding and contracting a billow or accordion, against a fixed, rigid strong and immobile structure, located above, creating a compressive and expansive force that becomes harnessed to generate Energy that is harvested on a constant basis by the use of propellers and an accelerating gear box, turns the generator.

### DESCRIPTION OF EMBODIMENTS AND OPERATION

To capture the energy there are several ways or means that can be practical, the floating devise and the firm structure remains the same, the part that is going to be compressed and extended can be:

A). An Accordion, Billow, FIGS. 1, 3, 4, 6, 7, 8.3 letter C, or Lung like structure that when the floating devise, FIGS. 1, 3, 4, 6, 7, 8.3 letter B, is pulled down (ebbing) it inhales air into the lung or billow through a constricted duct controlled by a calibrated valve or valves, letters I and J on the same FIGS. 1, 3, 4, 6 and 7, creating an air current that passes through and moves an impeller, FIG. 2 D attached to an accelerating gear, FIG. 2 I that transmit the force to a Generator, Alternator or Dynamo, FIG. 2 K; at the end of the ebbing, the valve closes, FIG. 2 B+, and with the billow full of air, when the tide starts to rise, it creates pressure to start exhaling the air, through a different calibrated valve or valves FIG. 2 A+, generating an air current through a propeller, FIG. 2 C, or the same one (impeller) just directing the air so it keeps the motion in the same direction, when there are several billows like when harnessing the power of waves, the inhaled or exhaled air can be directed and connected in a separate set of tubes or pipes and valves to a big turbine, that has an impeller and propeller in a common shaft, FIG. 2 H, in the same direction moving an accelerating gear, FIG. 2 J, that transmit the force to the generator FIG. 2 K. This is the main concept of my patent application.

B). An air Cylinder, FIG. 5 E, that acts as a pump like the ones used to inflate bicycle tires, is installed on the fixed structure and the plunger or piston, FIG. 5D, is attached to the floating device, FIG. 5B, with adequate and strong pole, FIG. 5C, and lateral guides, FIG. 5L, that keep the piston moving freely up or down inside the cylinder pushed by the force in the tide or wave on the floating device, creating pressure force moving the air, in and out of the cylinder under pressure, propelling the circular or on line turbine that moves the generator, FIG. 5F to K, again the valves J and I, will control the pressure and direction of the flow in the most efficient way to keep the propeller or propellers moving.

C). A Worm Gear, or Rack with gears in two sides, attached to the moving part, or floating platform, that will turn one pinion on the fixed structure when it is going up, when the rack moves down, by a disengaging mechanism gets away from that pinion and moves against and engages another pinion that turns in the way down, since both pinions move in opposite direction, it requires a gear motion converter, to make the movement in the same direction on a shaft with an accelerator gear to the generator, with the proper calibration or ratios, will move it with mechanical force, pulleys principles apply here, or it can be used on a ratchet type of spring like a winding in the old watches, with a disengaging mechanism at the end of each cycle similar to the one used on top of the ball pens to push the tip in and out.

D). A spring coil, that recoils in one direction when pushed up, and then releases slowly, like the movement of the watches as it releases the ratcheted pressure, and a second coil that recoils when the pressure is down, releasing again when loaded at end of cycle, in a measured and controlled way as it unwinds or uncoils.

### PREVIOUS ART

U.S. Pat. No. 4,355,511 dated Oct. 26, 1982 by Jones differs with mine because it is submerged, different in shape, it is a floating structure not fixed or near the shore, we are trying to utilize large volumes of air, or hydraulic power to generate electricity, mine does not use weights, the floating devise is heavy enough, mine does not hold the floating devise up until the end of the cycle, except by the control valves that allows air to flow out or in when pressure is adequate to move the propeller or impeller like in a steam kettle, my devise depends on the weight of the floating devise to pull in the accordion to inflate with the air passing through the impeller and the floating devise when is lifted to squish the accordion against the fixed structure to exhale the air contained in it through the propeller, in my invention the propeller end expeller are in the same shaft and can be one and the same with the air impelled pushing the flutes or blades from a different angle with a separate inlet and the expelled air to flow into the propeller in the same direction of the rotation with an exhaust opening insolated from the impeller inlet, no containers just free flow, or one impeller and one propeller separated from each other moving the same shaft in the same direction. The supporting structure that holds and contains the floating platform, has to be strong and rigid enough to withstand and prevent lateral motion of my device, and the weight and pressure upwards and downwards against and from the platform by the floating device and the accordion.

U.S. Pat. No. 3,668,412 dated June 1972 by Vrana uses ratchet type of accumulation in prefabricated structures, they use tanks we use anchored pillars only to support and lateral restriction of movement of floating devise without impeding the flow of water, no restrictions on the vertical movement except by the opening and closing of the valves when they reach operational pressure, they have a duct allowing water into the tank where floating devise is located, they use a ratchet in an arch, that gathers only upward movement, not when the float goes down, mine harvests the upward movement, disengages at the end of the movement, and another ratchet engages when the movement goes on the opposite direction, with a mechanism of engagement and disengagement similar to the one in the one pushing the ball point pen in and out, or some ratchet similar to the one used by this previous art but that uses the downward energy. No locks or electricity to control underwater valves, they use the water that goes in and out of the tank under sea level. My devise uses the tides or waves to create a Lung effect of large masses of air passing through a constriction with a valve, as the accelerated air rushes in or out creates force to move the propeller or impeller as the case may be.

U.S. Pat. No. 4,228,360 dated Oct. 14, 1980 by Navarro converts wave motion to kinetic energy, anchored on bottom of ocean floor and a pulley and a cable from onshore a floating devise coils or uncoils a ratchet, my having platform by the shore on top of floating devise, the pulley only takes one direction of the movement to generate, fly wheel dispels one of the movements.

U.S. Pat. No. 5,066,867 dated Nov. 19, 1991 by Shim it has floating devises controlled from the ground or from floating platforms to piston movement, anchor and framing submerged, support member and pulley under sea level. Floating bladder with a hold under one end of a rope to a fixed anchor, major control of floating devise is by cables.

U.S. Pat. No. 4,754,157 dated Jun. 28, 1988 by Winddle has all the mechanisms submerged, pumping water to shore and water propeller is on shore, mechanisms of pumping water are under water.

U.S. Pat. No. 20,020,131,523 dated Sep. 19, 2002 by Sherman and Martin is concerned with the flow of water of the tide as it flows in and out of a holding area.

U.S. Pat. No. 20,050,001,432 dated Jan. 6, 2005 by Alexander liquid flows through underwater turbine.

U.S. Pat. No. 5,872,406 dated Feb. 16, 1999 by Ullman relates to a movable tank associated with hydraulic cylinders, up and down tank generates electricity, it is an enclosed system in which the controlled inflow and outflow of water between enclosure and surrounding water generates electricity, a bellow fills with water, it is bellow the floating devise in a walled tank in which the effect of tidal water fills the tank and utilizes the flow of water to the tank to generate electricity, Bellows are located below a stationary tank at bottom below the water at bottom of tank, never to extend above lower tide level at adept of 120 feet or less, it gets filled with water from the bottom, mine operates with air, bellow is submerged, fills with water or water and air makes it more corrosive, the water tank above that fills with water creates the hydraulics, with underwater electrical valves; my system is simpler and operate with pressure sensitive valves exclusively, the weight of the floating devise pressing upward or pulling downward on the billow generates the pressure necessary to make the flow of air through the constriction with speed and force move the propeller, no necessity of tanks, only pillars like under piers, marinas and bridges or structures that can be built without interfering with the flow of water, by tanks with walls.

U.S. Pat. No. 20,040,150,234 dated Aug. 5, 2004 by Bradley harness with floating devise back and forth and up and down, using pulley and cable.

U.S. Pat. No. 20,050,029,817 dated Feb. 10, 2005 by Gizara a gimbals depend on the acceleration of the flow of water, not on buoyancy.

U.S. Pat. No. 20,050,035,602 dated Feb. 17, 2005 by Gard depends on two masses of water, one sinks and the other floats.

U.S. Pat. No. 6,731,018 B 1 dated May 4, 2004 by Grunsted relates to moving water at an opening at the bottom of tank, like a hydroplane rotating cylinder like underwater windmill facing the current by a fin like the tail of plane, depends more on the flow of water than in buoyancy.

U.S. Pat. No. 5,575,587 dated Nov. 19, 1996 by Chen flow of water from the waves into a big opening of a funnel pushing air into a small constriction on top to propel, does not depend on buoyancy.

U.S. Pat. No. 4,682,473 dated Nov. 11, 1986 by Curry a grid floating offshore of reciprocating floating devices that pushes fluid into and from reservoir with two generators, one for the fluid going into the reservoir and the other for the fluid getting out of the reservoir sending energy to shore.

### BACKGROUND OF INVENTION—OBJECTS AND ADVANTAGES

The great thing about this type of generation of energy is that it is ecologically sound, exist already and is only harnessed, not consumed, almost inexhaustible source of energy, does not contaminate or leaves any residue, and is kind to nature; existing structures can be used, old boats, barges, storage tanks that float, old oil drilling offshore platforms, or fabricated; old or existing piers, bridges, marinas, etc. or can be built for that purpose with minimal interference with nature, and no contamination.

Besides the obvious advantages that can be obtain from producing Electrical power by means of harnessing the energy generated by the rise and fall of the tides and the waves, and the push and pull to and from the shore in the case of the waves, among them but not limited to these advantages:

The energy is Constant, Predictable, Abundant, Inexhaustible, Clean, Ecologically much more sound than Atomic or Hydrocarbons in its generation and in its usage, relatively inexpensive to build and to operate, easy to harvest, uncomplicated, not too many costs up front or operational, passive collection, no more damaging to the environment than barges and boats floating, it can be very large or smaller, in the case of the waves the littorals of all the continents is so baste and large that harvesting the waves in a small amount of shores, like 5% of the coast can generate all the energy needed for world consumption, this is a guess, the benefits are innumerable.

The advantages of the present invention are:
A). The simplicity of operation and of its components:
   a.) A Solid Structure on pillars, FIGS. 1, 3, 4, 5, 6, 7, 8.3, 8.4 letter A, already existing or built for it, high enough to allow the space necessary for the floating devise and the billow to move freely in the highest predictable tide or highest waves, strong, and in case of severe weather could allow the devise to be taken away before the storm to a shelter and repositioning it in place by means of one or two pillars that can be telescoped in and out of the pylons; to contain and limit the horizontal movement of the floating devise, that resists the forces exerted by the accordion attached both on top of the floating devise and bellow the structure, when the floating devise is pushing it up or pulling it down or front and back, creating positive and negative pressure or the inflation or deflation, and the movement to and from shore harvesting horizontal forces compressing balloons or accordions or billows on the limited movement of the floating devise in the direction of the waves, like a cushion, in the case of the devise in the tides where there is no waves, the need for strength for lateral movements is less and no need to harvest the horizontal forces, so the lateral movements can be more confined.
   b.) A set of accordions, pillows, billows or lungs strategically located, FIGS. 1, 3, 4, 6, 7, 8.4 letter C, in the case of the tides one or if the structure is very large, several, to withstand the accumulated pressure if that is required, preferably one, large and strong, on top of the floating device, FIGS. 1, 3, 4, 5, 6, 7, 8.3, 8.4 letter B extending the whole surface of the floating devise, FIGS. 1, 3 and 7, to maximize volume, expandable up or down enough to fit the highest and lowest tide; in the case of the waves, one or several large ones on top, FIG. 4, the same as the one on the tides, and then to capture the teeter totter that is created in front and the back of the floating devise, when the front is lifted by the wave, it compresses the front billow, at the same time it expands the back one and vice versa when de wave passes to the back of the floating devise, besides that the other larger pillow on top is harvesting the total lifting of the barge or floating devise; added to that the little movement allowed to and from following the wave can be harvested by billows or cushions placed in front and back horizontally.
   c.) Constricted Outlets and Inlets, regulated by check valves, FIGS. 1, 3, 4, 5, 6 and 7 with letters I and J, and in FIG. 2 letter A+ and B+, that automatically open when certain pressure is achieved and when there is change on the direction of the flow, some of them will allow air into the billow some of them will allow air out of the billow, to pressure resistant hoses or pipes that direct the accelerated air from the compressing billow into the propeller or suck the air from the outside through the impeller to the expanding accordion, the position of the entrance of air into the impeller and the out flow of air through the propeller makes them move the shaft in the same direction; both prop and imp are circumferencial and attached in the center to a shaft or axel that rotates by their force, the shaft transmit the rotation to an accelerating gear box and from there to a Generator or Alternator depending of the size, like in the cars but made for the generating capacity, based on the force engendered, and from there, transmission lines take the Electricity to the grid or to batteries. FIGS. 1, 3, 4, 5, 6 and 7 with letters D, E, F and G, FIG. 2 C to L.
B). It is relatively inexpensive to build and operate, since the structure that is needed for supporting and encasing could be already existing, like under bridges in areas of lagoons or inlets, piers, marinas, harbors, etc. the floating devises can be boats, tankers, barges that may be rejected for navigation but capable of floating, of course the structure and the floating devise can be made for the purpose in which case it could be design for better efficiency; the expenses that need to be done are for the bladders, billows or accordions, valves, hoses and propellers, gear box and generator, the billows have to be made strong resilient and lasting, rubber, plastic or other materials suitable for the job.
C). It is efficient because in contrast with previous art it harvest forces up and down, front to back. Up and down of the whole structure, in the tides and in the waves pushing the structure up and down, then there is the teeter totter effect when the front, or facing the wave is lifted by the incoming wave squeezing the air out of the frontal accordion, while the back is stretched down pulling air, and vice versa as the wave passes to the back of the floating devise, and then, we can, in another embodiment, harvest the pressure towards shore, on a horizontal direction, exerted by the wave and backwards making the billow or cushion properly placed in front and back of the floating devise, either inflate or deflate according to the direction that the wave is pushing or pulling; the air gathered or expelled will go through hoses, pipes and valves to propellers or impellers either one of each or multiple, depending on the size of the project, mounted in the same shaft going in the same direction, all movement is converted into air going in or out generating energy like the lungs in a body. Emphasis on clean, abundant, nature friendly and inexpensive.
D). Easy to replicate in a variety of structures, existing or created, any location where there is a coast line the temperature, is not a factor except for the materials that need to adapt to the circumstances; any shape, size, and design, extremely versatile.
E). The construction is such, that in the event of a forecast of a storm, maintenance, repairs, the floating devise can be detached and carried unto shelter while the accordions can be retracted and redeployed by means of a disengaging and engaging mechanism when the danger of damage has subsided, or the repair is done, in the case of the multiple devises in sequence, they can be done all the same size so they can be replaced with spare ones, this can be achieved by making one or two of the pillars detachable, retractable or that can swing open when the need arises.

Another embodiment could use ratchets instead of billows, previous art only harvest one direction of the movement, in the present embodiment if we use ratchets we would harvest the going down of the floating devise as well as the going up, with a rack and pinion devise similar to previous art except for the mechanism that engages one pinion when the floating devise is pushing in one direction, and disengages the one that moves contrary and when the floating devise goes in the other direction, it disengages the one that moves in the opposite direction and engages the one that goes in the new direction, and vice versa at the end of each cycle, with a mechanism similar to the retractor of the tip of the ball point pen; the energy is collected in a spring coil either as the winding of the watches or old clocks, or like the springs in the shock absorbers of the cars, that when they get to a predetermined tension, release the coil or the spring with the force, calibrated in between certain parameters of efficiency, is directed to the shaft, to the accelerating gear box on to the generator or alternator, that convert the rotating force into Electricity.

Yet, another embodiment could use springs, directly attached to the floating devises, that recoil and releases at the end of the movement in one direction, and another engages to do the same in the opposite direction, the force from these springs can be harvested by means of a rack attached to the released spring to a pinion that moves the shaft, disengages when the force is not adequate or efficient, again, the mechanism of the engagement and release of the retractor of the ball point pen can be one of the means to operate the adequate position of the active or inactive pinion and rack.

Another way to collect the pressure of the floating devise would be a large piston inside a cylinder, containing air, FIG. 5, with hoses that apply the direction of the pressurized air to propellers or impellers as the preferred embodiment, the cylinder filled with air, it seems to me that it will be less efficient than the accordion or billow or balloon, because the diminished capacity of the cylinder and the need for more lateral immobilization of the floating devise so the piston can push straight up.

### DRAWINGS:

FIG. 1.—Shows the basic components of the device used on the harvest of tidal energy:

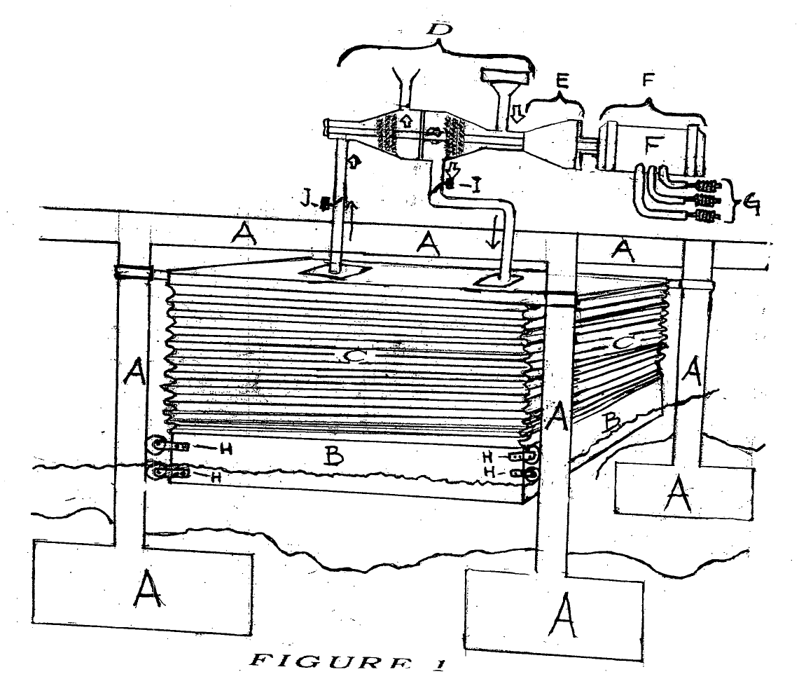

A.—supporting structure.

B.—floating platform, with: H.—rolling guides to limit its lateral movement.

C.—accordion or billow, with ducts and valves leading to and from prop and imp.

D.—propeller and impeller.

E.—accelerating gear box.

F.—generator or alternator.

G.—wires conducting electricity from generator.

I.—inlet valve.

J.—outlet valve.

FIG. 2.—Shows the processor where accelerated air forces are converted to electric energy:

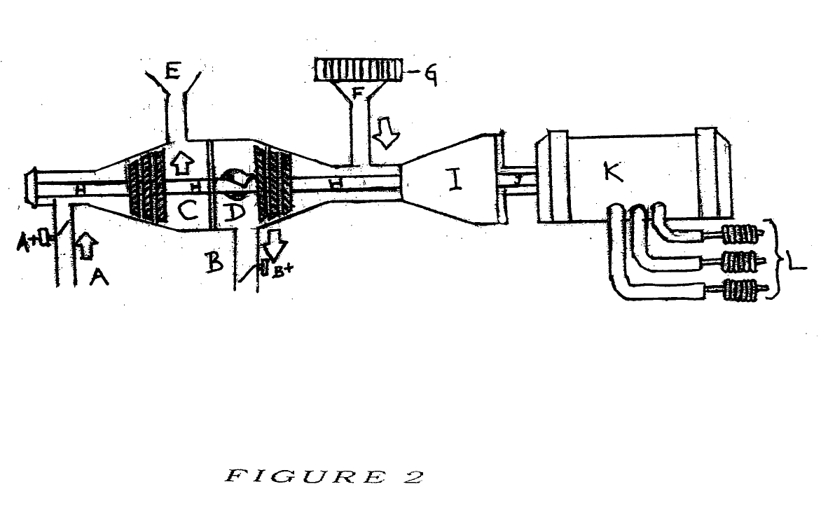

A.—outlet ducts from one or multiple accordions, billows or cylinders, A+.—one direction check valves.

B.—inlet ducts to one or multiple accordions, billows or cylinders, B+.—one direction check valves.

C.—propeller.

D.—impeller.

E.—air exhaust opening.

F.—air intake opening.

G.—intake air filter/screen.

H.—rotational shaft from the propeller and impeller to:

I.—accelerating gear box.

J.—shaft from accelerating gear box to:

K.—alternator or generator.

L.—wires conducting electricity generated, to grid or to batteries.

FIG. 3.—Shows another type of tide harvester, with a different kind of propeller and impeller, but same basic components: A.—Supporting, holding structure, B.—Floating platform with rolling guides H attached to the sides gliding up or down on the vertical supports of A, C.—Accordion or Billow with openings above one for letting air in and another for letting air out, with their respective valves I and J. The arrows signal the direction of the air and direction of the turn of the shaft.

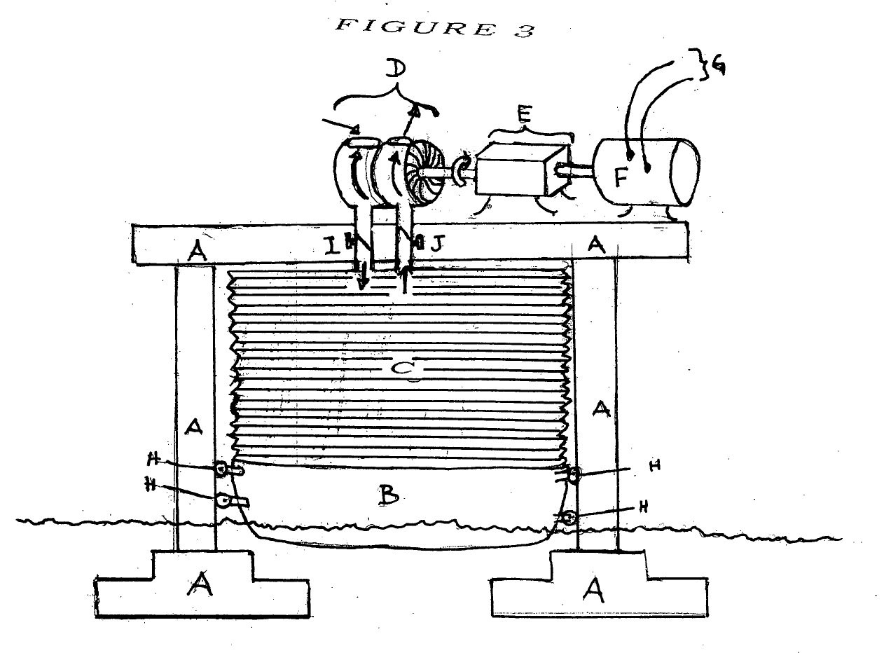

FIG. 4.—Represents one embodiment to use in harvesting of wave energy. With: A.—Supporting and encasing structure, B.—Floating platform with bottom designed to make more up or down when the wave, passing under makes it teeter totter; C.—Accordions or billows, C1 located in front, C2 located in rear, C3 located in middle mounted above the range of movement of C1 and C2, on top of hinged supports H that allows certain allowance for the teeter totter and to and fro of the floating platform, K one of the two poles that support the bottom of billow C3, that telescope up and down through A limiting horizontal movement of C3 and B, the arrows represent direction of movement or flow of air.

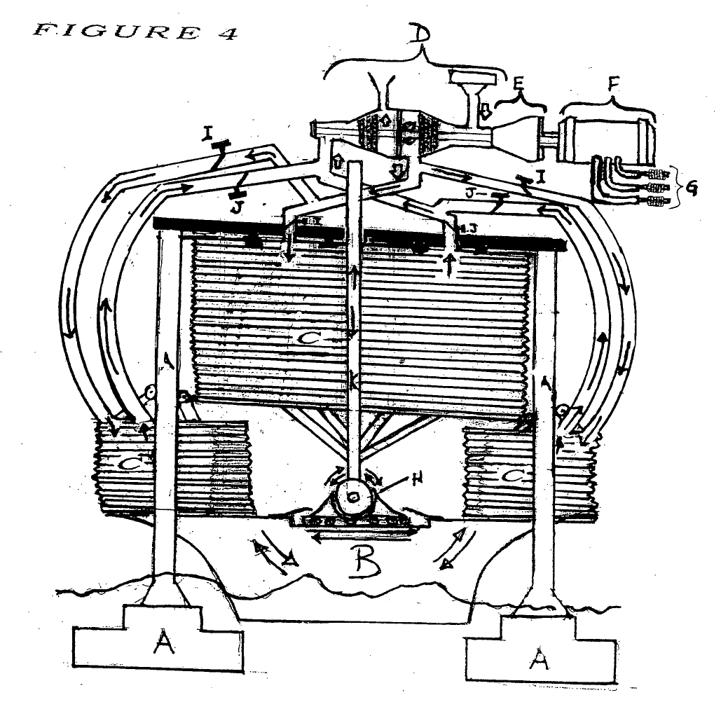

FIG. 5.—Represents another embodiment of the device, in which we use a cylinder and a piston instead of the billow, where A.—is the supporting structure B.—is floating platform with guiding casters pointed by arrows, C.—pole supporting and pushing piston, D.—piston, E.—cylinder shaft, F represent the propeller and impeller complex, G accelerating gear box, H.—generator, I inlet valve, J.—outlet valve, K.—electrical wires, L.—guides that guide and stabilizes in their guiding tracks.

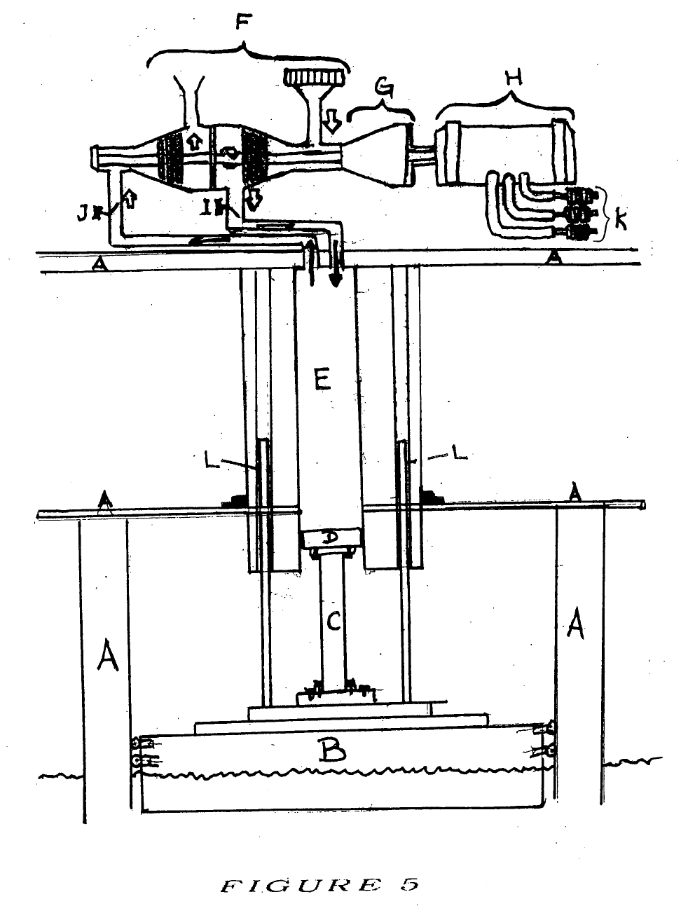

FIG. 6.—A devise for harvesting waves, that present multiple floating platforms with their respective billows on top that can be replicated and multiplied as much as desired: A.—supporting structure, B.—floating platform with C.—accordion or billow on top, D.—propeller and impeller ensemble, E.—accelerating gear box, F.—Generator, G.—wires conducting electricity generated, I.—Inlet valves in inlet ducts system, J.—Outlet valves in outlet duct system.

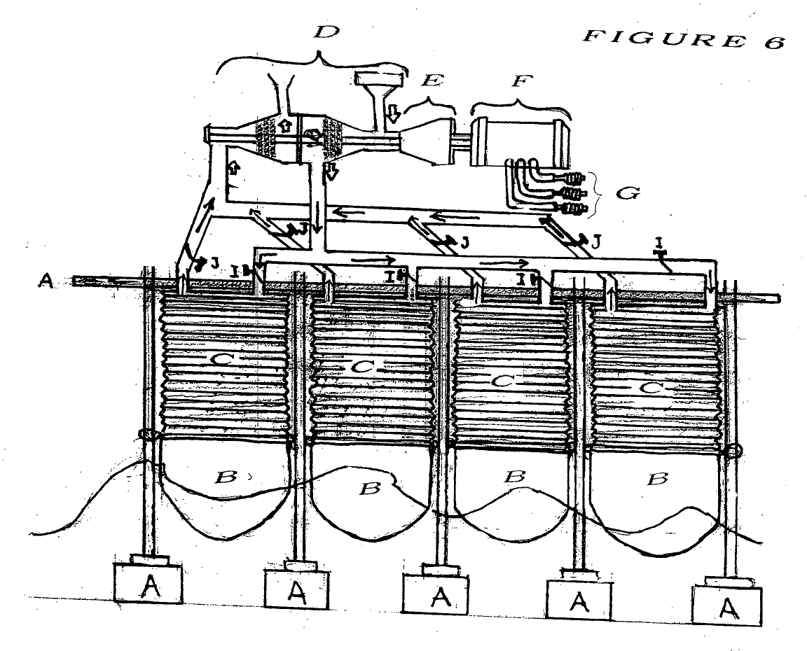

FIG. 7.—A simpler model of the devise for use for harvesting waves, with: A.—supporting structure, B.—floating platform with H.—casters to control horizontal movement, C.—accordion or billow, D.—propeller and impeller complex, E.—Gear box, F.—generator, G.—electrical wires, I and J inlet and outlet valves.

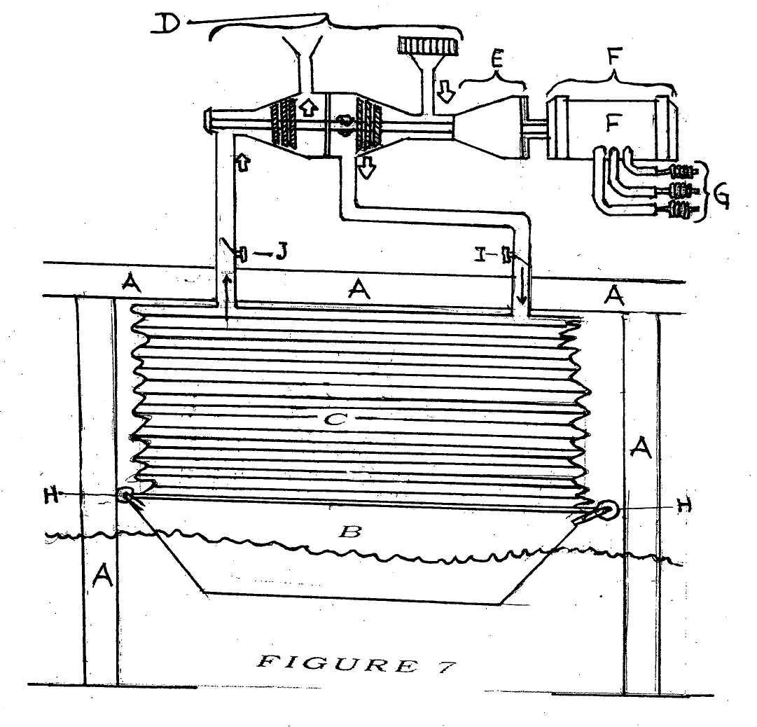

FIG. 8.-8.1 and 8.2 represent the utilization of a bridge and a boat for making the devise, 8.3 letter A represent supporting structure, B the floating platform, that happens to be a boat in this particular representation, 8.4 letter C represent the accordion or billow, 8.5 represent a different kind of turbine in which air enters the front.

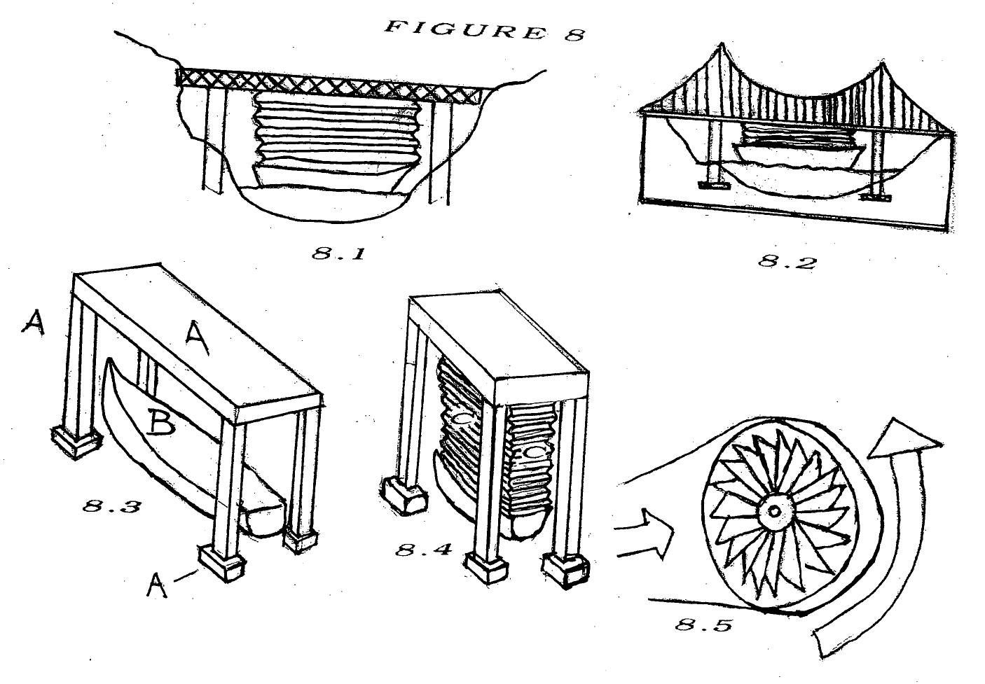

1. A means of capturing energy from tides and from waves by utilizing a heavy floating device, with a billow or accordion attached on top of it, with a firm and immobile structure holding a means to attach the billow's opposite side, thus the floating devise pulls and pushes the billow while the structure above holds firm and opposes the pressure or the pull exerted by the floating device when it goes up or down by the tide or the waves, making the billow inflate and deflate, like a lung between the rib cage and the back, the firm structure has the function too of limiting the movement of the billow and the floating devise, within certain parameters to an almost only vertical movement with very limited horizontal movement, except in some applications.

2. Said device captures the energy generated from the compression and expansion of the accordion or billow that is placed between the moving up or down of the floating devise, against an immobile structure opposing such movement, generating air movement in or out of the hollow chamber of said billow or accordion.

3. Said device has a Valve or a Set of valves that automatically open when the air goes out of the accordion or billow once it reaches a certain pressure, and closes when the direction of the air changes, namely when the air start to go into the accordion, pulled by the negative pressure inside the accordion when the floating devise is moving away from the fixed structure to which the accordion is attached, at which time another Valve or set of Valves, open to let the air when a certain pressure is reached, into the accordion or billow.

4. Said device has two sets of pipes, conduits and or hoses, one set's function to allow the air that is expelled from the accordion or billow, from the corresponding valve and delivers it to a turbine or propeller causing such propeller to move, the other set will let the air in, sucked by the negative pressure when the accordion or billow is being pulled by the floating devise, such sucked air before it comes through the conduit or pipe has been passing through an impeller or turbine making it move.

5. Said device has a shaft to which a propeller and an impeller are attached in a way that both move the shaft in a circular motion of the same direction when the air is inhaled or expelled through them, causing them to move, causing the axel to move, by placing the inlet from the outside in a certain direction and the outlet from the accordion in another certain way that makes both to turn in the same direction, moving the shaft always in the same direction; although they are attached to the same shaft, the air inside each one of them does not mix and there are no communication between both.

6. Said device's shaft that is moved by the propeller or impeller deliver that circular motion to an accelerating gear box, that multiply the velocity of the rotation delivering it to another shaft that will move a Generator or Alternator which converts the accelerated rotational energy into Electricity, that depending of the application, can go to the grid or to batteries.

7. Said device described above when used to harvest tidal energy only, which means that is placed in a sheltered area where water levels go up or down at a relatively slow pace, requires larger volume due to the slow pace of the inflation or deflation of the accordion or billow, so bigger is better, as much as the imagination allows and the selection of the shelter area, multiple devises can be replicated transferring the air to a single set of turbines or multiple sets, size of a football field or bigger or multiple smaller ones.

8. Said device can be built from scratch for that purpose or utilize existing structures or objects that can be adapted for that purpose diminishing the outlays of initial expenses; for example, among existing firm structures come to my mind but not limited to: Existing bridges over tidal inlets or bays, gang ways of marinas, harbors, under existing harbors or piers when supported by pylons; as floating devises we could utilize rejected barges, tankers, boats that could be unsafe for navigation but capable of floating, empty barrels, alone or united together, as many or as few as we want the size of the devise or the site permits it, all the floating devises when they are not heavy enough to be pulled down can be united by a heavy platform to which the accordion or billow is attached.

9. Said device when harvesting the energy of the waves, requires a firmer structure, close or by the shore, capable of withstand the forces applied by the surf while keeping under it, encased, with certain latitude of horizontal movement the floating devise and with them the accordions or billows.

10. Said device's accordion or billow has the flexibility to permit some lateral movement, sidewise and back and forward when the floating device is moved around by the waves and undertow.

11. Said device, when used in open water shores, as opposite of sheltered bays and harbors that only withstand tidal movements, consist of the same components, and can be one accordion or billow on top of the floating devise, covering the whole surface, or two independent accordions or billows one in the area facing the open sea or front and the other in the rear of the floating devise or facing the shore, since the barge or floating device, being elongated will move as a teeter totter when the front is lifted by the wave, the back will be moving down and when the wave passes to the back, the front goes down while the back goes up; a third accordion or billow can be placed higher up, without interfering with the two other billows' movements, on a limited tolerance hinged support or supports, that allows the teeter totter, in the middle of the floating device, between front and back of floating device that captures the movement up or down of the whole floating device.

12. Said device in waves with a simple small floating device and accordion, can be replicated, each one independent of each other, in a honeycomb, squared or round configuration, next to each other, with its independent two valves, connected to a pipes system that convey the air exhaled or inhaled to a common impeller or expeller.

13. Said device in open water shores, can have one front and one back accordion or billow, that captures the movements up or down, and another set of billows or accordions, one in the front and the other in the back, on a horizontal plane, above the water, that harvest the back and forward movement of the floating device, within certain latitudes, so that when the waves push the floating device back, it compresses the back billow or accordion, while the front is expanded, and vice versa when the wave passes, valves and connections the same, this embodiment requires more latitude of movement of the floating device to and from the shore, but not necessarily to the sides.

14. Said device's containing cage where the floating device is encaged, under the structure, has a means by which the floating device can be removed out for repairs or maintenance, or when a prediction of severe weather, such means can be some telescopic or retractable poles or bars, or a gate that can be open, allowing the floating part out, or in.

15. Said device's accordions or billows, can be detached or attached from the floating and from the platform by means of locking devices, latches, fasteners or any other means that can hold firm and let go when needed, to replace the billow or accordion, that can be made of few standard sizes, so when they are removed, for repairs, ruptures, maintenance or weather problems, with the openings for in let or out let of air being capable of sealing against the duct that leads to the valves when they are put back into place.

16. Said device has all the valve systems and ducts on top of the rigid structure where they can be easily accessible to provide maintenance or replacement if needed. Valves should be self activated by the pressure and direction of the flow.

17. Said device have the propellers and impellers in the same shaft, the propellers and impellers can be any kind that is efficient, we are inclined to use the turbine type like the one used with the air coming from the front as the windmills or the air coming from the side like the air rotor on dental drills, and they must direct the turns always in the same direction, but there is no communication between them or mixing of the air going in with the air going out.

18. Said device, at the inlet of external air before it goes into the impeller will have a means to filter the incoming air from debris or contaminants like small rocks or excessive moisture that can damage the flutes of the impeller, clog the ducts or diminish the durability of the inside parts.

18. Said device in sheltered areas where tides are the only source of movement will be most efficient with larger units with larger billows to generate more volume with slow movement, whereas the ones used on the shores to harvest waves can generate more energy with smaller units due to the constancy, frequency and height of the movement generated by the waves.

19. Another device that captures tidal energy consist of the floating device has on top a pole with a large piston on top, that fits into a large cylinder that is attached to the firm structure above, that does not interfere with the movement up during tidal lift, immobilized laterally by parallel guides that move up and down inside parallel tubes mounted in the fixed platform, that keep the piston and the cylinder always parallel and centered, acting as the bicycle tire pump in a large and wide scale. This same device can have the piston mounted on a hinged strong pole that allows limited lateral movement of the floating device to which the pole is mounted without interfering with the piston moving centered in the cylinder, in this device if there is need for parallel guides up and down could be done by allowing certain slack on the tubes mounted on the rigid platform, this can be used when harvesting the energy of waves, allowing more mobility of the floating devise while the piston is pushed up and down inside the cylinder, again one or more cylinder and pistons can be put in the same floating device capturing the teeter totter and the lift of the whole floating device as the wave passes under it; the valves, ducts, turbines etc. are in the same configuration.

20. Another device that captures energy from tides and waves has instead of the accordion or billow on top of the floating platform several racks that are pushed and guided up and down, engaging one pinion in one side when the floating structure lifts the rack, and disengage when the floating structure starts to pull the rack down, the notches in the opposite side of the same rack engages the other pinion that captures the energy of the floating structure going down, the engaging and disengaging mechanism of the two pinions in each ratchet, can be accomplished by a pallet that rides the notches of both pinions, when the direction of the movement reverses, the pallet, mounted on a hinge makes the rack move away from one pinion and close to the other, and vise versa, similar to the one on pendulum clocks, or any other mechanism that accomplishes the same objective. The turning movement of the pinions can be harvested to shafts that winds a spring loading mechanism that discharge its load when reaching certain tension to generator directly or to an accelerating gear box that leads the force to a generator.

21. This other device when used in waves the racks sticking up should remain in the same vertical direction while the floating platform moves unevenly, although confined by the encasing structure, this can be accomplished by means of confined rollers and hinges that allow the floating platform's movement while the racks remain only moving up or down.

22. Another device that, similar to the previous one in which springs are attached to the floating platform and are compressed when such platform moves up and release at the end of the movement up unto a spinner leading to the generator, and on top of the fixed platform hovering on top of the floating platform, springs that are pulled when the weight of the floating platform is going down, that again releases unto a spinner that moves the generator when the movement changes, this disengagement and engagement can be accomplished by a mechanism similar to the ones used in ball pens to push the tip in and out or other similar means to get the engagement and disengagement.
